(19) United States
(12) Patent Application Publication
(10) Pub. No.: US 2025/0221512 A1
(43) Pub. Date: Jul. 10, 2025

(54) THREADED UNIVERSAL ADAPTER SYSTEM

(71) Applicant: L'OREAL, Paris (FR)

(72) Inventors: Mick Anthony Yoon, Brooklyn, NY (US); Casey Barbarino, San Anselmo, CA (US)

(21) Appl. No.: 19/014,957

(22) Filed: Jan. 9, 2025

Related U.S. Application Data
(60) Provisional application No. 63/619,016, filed on Jan. 9, 2024.

(30) Foreign Application Priority Data
Apr. 25, 2024 (FR) 2404278

(51) Int. Cl. A45D 40/26; A45D 40/00

(52) U.S. Cl. CPC A45D 40/265; A45D 2040/0006; A45D 2200/10

(57) ABSTRACT

A system and features related to a threaded universal adapter device for attaching to multiple types of cosmetic applicators and the like are described. The threaded adapter includes a first cylindrical portion with a first threading for engaging threading on a cosmetic applicator handle, and an attachment portion attached to the first cylindrical portion for engaging a device adapter holder, which can be then attached to an auxiliary device, such as a motion stabilizer device. The threaded adapter can further include a second cylindrical portion with a second threading for engaging threading on a neck of a cosmetic bottle to allow storing the cosmetic applicator and the cosmetic bottle attached to the threaded adapter.

### CROSS-REFERENCE TO RELATED APPLICATIONS

This application claims priority to, and the benefit of U.S. Provisional Application No. 63/619,016, filed Jan. 9, 2024, titled “THREADED UNIVERSAL ADAPTED SYSTEM,” and French Patent application Serial No. FR2404278, filed on Apr. 25, 2024, the disclosures of which are incorporated herein by reference in their entireties.

### FIELD

The present disclosure describes a system and features related to a threaded universal adapter device for attaching to multiple types of cosmetic applicators and the like.

### BACKGROUND

Cosmetic products having applicators can be attached to other devices, such as assistive devices for users having a disability. The attachment can be cumbersome since different manufacturers and models can have different designs and form factors.

Therefore, there is a need for a solution that facilitates the attachment of multiple types of applicators to other devices.

### SUMMARY

In one embodiment, the present disclosure relates to an attachment system for a cosmetic applicator, including a threaded adapter, including a first opening defined by a first cylindrical portion, an exterior surface of the first cylindrical portion including a first threading, and an attachment portion attached to the first cylindrical portion, the attachment portion being hollow, an exterior surface of the attachment portion having a shape; and a device adapter including a holder having a shape complementary to the shape of the attachment portion, the holder configured to reversibly attach to the threaded adapter via the attachment portion.

In an embodiment, the threaded adapter further includes a second opening defined by a second cylindrical portion, the second cylindrical portion being attached to the attachment portion opposite the first cylindrical portion, an interior surface of the second cylindrical portion including a second threading.

In an embodiment, the attachment portion further includes a first edge disposed proximal to the first cylindrical portion and a second edge disposed opposite the first edge on the attachment portion, and an abutment formed along the second edge of the attachment portion, the abutment configured to abut the holder and prevent the holder from moving beyond the second edge of the attachment portion.

In an embodiment, the holder includes a positioning liner along an inner surface of the holder, the attachment portion includes a groove around the exterior surface of the attachment portion, and the positioning liner is configured to sit in the groove of the attachment portion when the holder is fully engaged on the attachment portion.

In an embodiment, the exterior surface of the attachment portion includes a locating feature and an inner surface of the holder includes a complementary locating feature configured to engage with the locating feature of the attachment portion.

In an embodiment, the attachment portion includes a first magnet and the holder includes a second magnet, the first magnet configured to attract the second magnet and assist the holder engage with the attachment portion.

In an embodiment, the exterior surface of the attachment portion includes a series of teeth and an inner surface of the holder includes a complementary series of depressions configured to engage with the series of teeth of the attachment portion.

In an embodiment, the shape of the exterior surface of the attachment portion is non-circular and the shape of the holder is complementary to the non-circular shape of the attachment portion.

In an embodiment, the shape of the exterior surface of the first cylindrical portion widens starting from a first edge disposed proximal to the first cylindrical portion to a second edge disposed opposite the first edge on the attachment portion.

In an embodiment, the attachment portion is removably attached to the first cylindrical portion.

In an embodiment, the first cylindrical portion includes a locking feature configured to engage with a complementary locking feature on the attachment portion and prevent rotational slippage between the first cylindrical portion and the attachment portion.

In an embodiment, the second cylindrical portion is removably attached to the attachment portion.

In an embodiment, the second cylindrical portion includes a locking feature configured to engage with a complementary locking feature on the attachment portion and prevent rotational slippage between the second cylindrical portion and the attachment portion.

In an embodiment, the device adapter further includes a body attached to the holder.

In an embodiment, the device adapter is configured to attach to a motion stabilizer device via the body attached to the holder.

In an embodiment, the first threading is configured to engage with threading along an inner surface of a handle of the cosmetic applicator.

In an embodiment, the second threading is configured to engage with threading along a neck of a bottle.

### BRIEF DESCRIPTION OF THE DRAWINGS

A more complete appreciation of the embodiments and many of the attendant advantages thereof will be readily obtained as the same becomes better understood by reference to the following detailed description when considered in connection with the accompanying drawings, wherein:

FIG. 1 shows a threaded adapter, according to an embodiment of the present disclosure.

FIG. 2 shows the threaded adapter coupled to a device adapter, according to an embodiment of the present disclosure.

FIG. 3A-3C show images of threaded adapter and device adapter at various stages of engagement with one another and a cosmetic applicator, according to an embodiment of the present disclosure.

### DETAILED DESCRIPTION

The present disclosure describes a cosmetic applicator system that minimizes, modifies, mitigates, alters, reduces, compensates for, or the like unintentional movements by stabilizing, orienting, operating, controlling, etc. an applicator for a user and is also designed to be flexible to accommodate different types of commercially available cosmetic applications. The present disclosure further describes a system and features to enhance the functionality of such a cosmetic applicator system.

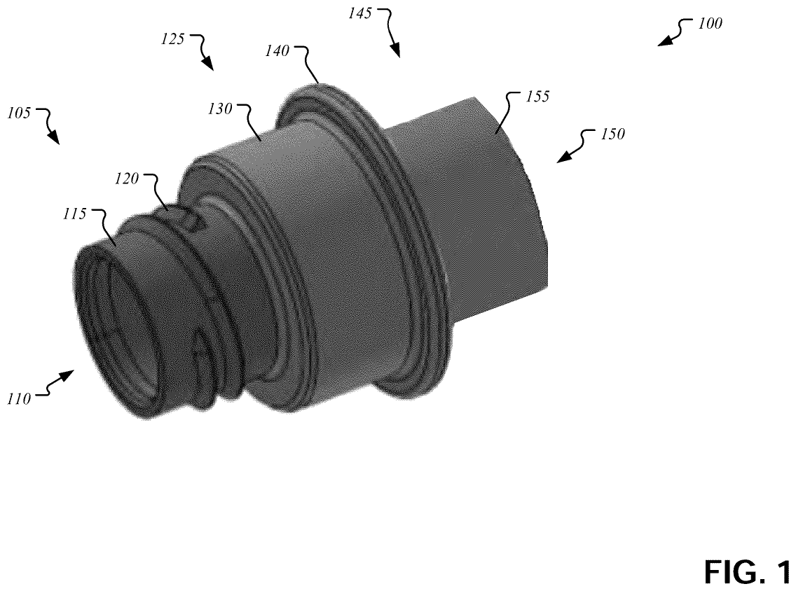

FIG. 1 shows a threaded adapter 100, according to an embodiment of the present disclosure. In an embodiment, the threaded adapter 100 includes a first opening 110 defined by a first cylindrical portion 105 and an attachment portion 125 attached to the first cylindrical portion 105. The first cylindrical portion 105 includes a cross-sectional shape that is circular, and an exterior surface 115 of the first cylindrical portion 105 includes a first threading 120 around the first cylindrical portion 105. For example, the first threading 120 can be a clockwise or counterclockwise threading, and the first threading 120 disposed on the exterior surface 115 of the first cylindrical portion 105 can be considered a male thread. The first threading 120 includes a pitch (crest to crest distance) and a pitch diameter. For cosmetic applications, the thread pitch can be course to improve the ease with which complementary threads engage with the first threading 120.

In an embodiment, the attachment portion 125 is hollow and forms contiguously with the first opening 110. That is, the threaded adapter 100 is hollow from the first opening 110 through the attachment portion 125 and an object can be inserted through the threaded adapter 100. An exterior surface of the attachment portion 125 includes or forms a shape. A cross-sectional shape of the attachment portion 125 is, for example, circular, oval, triangular, square, pentagonal, hexagonal, or any shape with n sides, among others. Notably, the cross-sectional shape need not have sides with equal length and can be a predetermined, freeform shape.

In an embodiment, the attachment portion 125 includes an abutment. The abutment is formed along the exterior surface of the attachment portion 125 and is a protrusion of material raised above the exterior surface of the attachment portion 125. The abutment is configured to, for example, prevent translation of an object arranged on the attachment portion 125 beyond a predetermined area of the attachment portion 125. For example, the attachment portion 125 includes a first edge disposed proximal to the first cylindrical portion 105 and a second edge disposed opposite the first edge along the attachment portion 125, and the predetermined area is the second edge of the attachment portion 125. For example, the predetermined area is a center of the attachment portion 125.

Additionally or alternatively, in an embodiment, the threaded adapter 100 includes a second opening defined by a second cylindrical portion. The second cylindrical portion is attached to the attachment portion 125 opposite the first cylindrical portion 105. Similar to the first cylindrical portion 105, the second cylindrical portion includes a cross-sectional shape that is circular. Further, in an embodiment, the second opening forms contiguously with the attachment portion 125 and the first opening 110. That is, threaded adapter 100 is hollow from the first opening 110 through the attachment portion 125 and the second opening, and an object can be inserted through the threaded adapter 100. As shown in FIG. 1, an exterior surface 155 of the second cylindrical portion is smooth, but can also be threaded to engage with other internally threaded objects.

In an embodiment, an interior surface of the second cylindrical portion includes a second threading. For example, the second threading can be a clockwise or counterclockwise threading, and the second threading disposed on the interior surface of the second cylindrical portion can be considered a female thread. The second threading includes a pitch (crest to crest distance) and a pitch diameter. For cosmetic applications, the thread pitch can be course to improve the ease with which complementary threads engage with the second threading. Notably, the pitch diameter of the second threading need not be the same as the pitch diameter of the first threading 120.

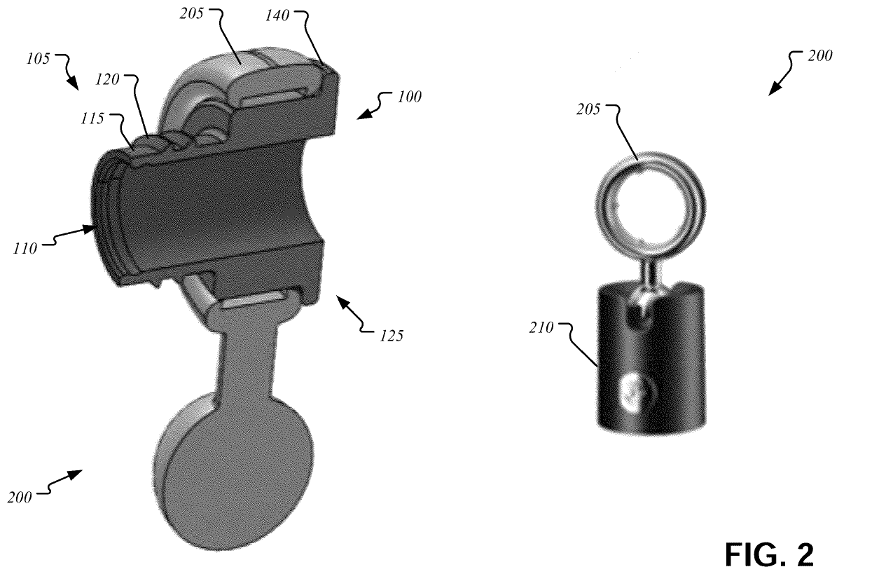

FIG. 2 shows the threaded adapter 100 coupled to a device adapter 200, according to an embodiment of the present disclosure. In an embodiment, the device adapter 200 includes a holder 205 and a body 210. The body 210 can be connected to another device that minimizes, modifies, mitigates, alters, reduces, compensates for, or the like unintentional movements by stabilizing, orienting, operating, controlling, etc. an applicator for a user, such as a motion stabilizer device for users with tremors. The body 210 is connected to or forms the base of the holder 205. Various configurations of the device adapter 200 can be used for different cosmetics and tools. In an embodiment, the device adapter 200 is easily attached to and removed from another device. In an embodiment, the device adapter 200 broadens the range of motion of a cosmetic applicator to enable movements that are necessary for cosmetic application. In some embodiments, the device adapter 200 is attached to a stand or carriage for further actions to be performed with a cosmetic held or retained by the cosmetic applicator.

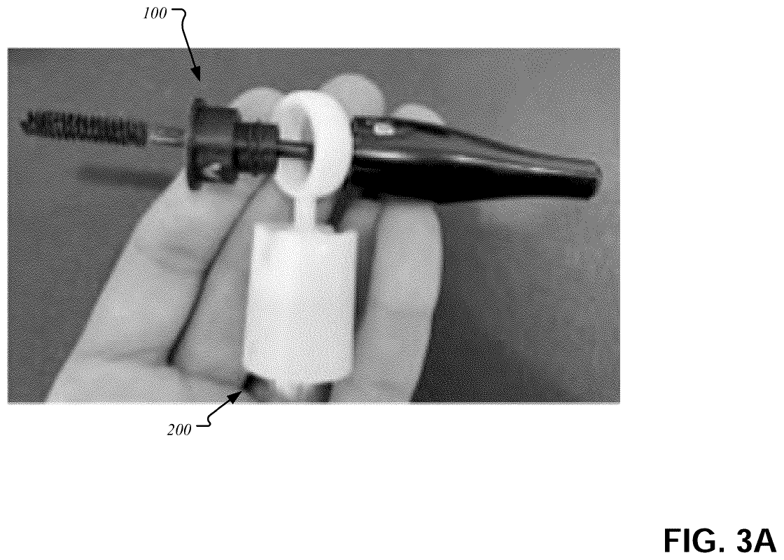

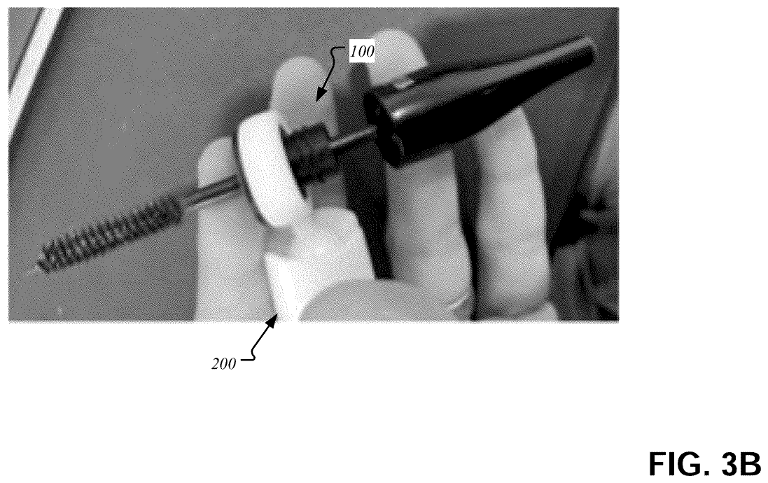

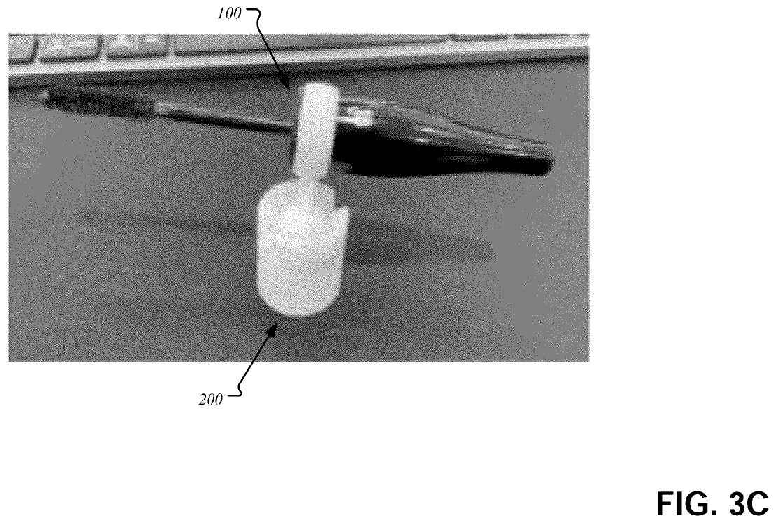

Engagement of the threaded adapter 100 with a cosmetic applicator and engagement of the threaded adapter 100 with the device adapter 200 is described herein with reference to FIG. 3A-3C to provide a threaded universal adapter system. Advantageously, the threaded adapter 100 provides a more universal solution because the first threading 120 includes a pitch diameter that is similar or identical to a pitch diameter of the threading on a bottle storing the cosmetic that the cosmetic adapter is packaged with. That is, various cosmetic applicators can have handles with varying designs and dimensions that limit the options for adapters that can be secured to an exterior of the handle. Thus, the threaded adapter 100 described herein leverages the more universally ascribed to bottle neck thread pitch diameters to which the handles are coupled and secures to the inner threads of the handle instead.

FIG. 3A-3C show images of threaded adapter 100 and device adapter 200 at various stages of engagement with one another and a cosmetic applicator, according to an embodiment of the present disclosure. In an embodiment, the cosmetic applicator, such as a mascara brush, includes a handle portion and an applicator stem with a tip that includes bristles or other flocking material to hold or retain a cosmetic product, such as mascara. Generally, the handle portion includes an interior surface having threads thereon (female threads) to engage with a bottle storing the mascara (or other cosmetic product) via a threaded neck of the bottle (male threads). The tip and stem of the cosmetic applicator can be inserted through the threaded adapter 100 via the first opening 110 and then through the attachment portion 125 until the first cylindrical portion 105 approaches the handle portion. To secure, attach, or fasten the cosmetic applicator to the threaded adapter 100, the pitch diameter of the first threading 120 is similar or identical to a pitch diameter of the bottle and configured to engage with the female threads of the handle on the interior surface of the handle. The handle and/or the threaded adapter 100 can be rotated as the handle and the threaded adapter 100 are brought together to engage the first threading 120 with the threading of the cosmetic applicator. While the design and dimensions of the handle can vary widely, the pitch diameter of the first threading 120, female handle threading, and bottle neck threading can be one of few commonly used dimensions, such as 10 mm, 13 mm, 15 mm, or less than 25 mm.

In an embodiment, the shape and dimensions of the holder 205 are configured to engage with the attachment portion 125 of the threaded adapter 100. The holder 205 can be arranged on the attachment portion 125 by sliding the holder 205 over the handle when the handle is sufficiently narrow. However, as described previously, often times the handle design and dimensions prevent adapters from fitting over the handle. Therefore, as shown in FIG. 3B, the holder 205 can be engaged with the attachment portion 125 prior to coupling the threaded adapter 100 to the handle of the cosmetic applicator.

In an embodiment, the shape of the attachment portion 125 and the holder 205 are both rings, with an outer diameter of the attachment portion 125 being similar to or marginally narrower than an inner diameter of the holder 205, and the attachment portion 125 and the holder 205 are reversibly engaged via friction forces. For example, the holder 205 is press-fit onto the attachment portion 125. Similarly, a material of the holder 205 is partially deformable or elastic to provide a tighter fit. In an embodiment, the holder 205 includes one or more projections along an inner wall of the holder 205 and extending outward into the center of the holder 205. Contact and friction between the one or more projections and the inserted attachment portion 125 can result in a more secure grip or hold of the holder 205 around the inserted attachment portion 125. In some embodiments, the inner wall of the holder 205 can be lined with a material that can improve the grip or hold of the holder 205 around the inserted attachment portion 125. The improved grip can be a result of a material property, such as a coefficient of friction (or the material deformation). For example, the inner wall can be lined with rubber or silicon. In an embodiment, the lining material can be a textured material with grooves, ridges, bumps, or similar features that prevent movement or slippage of the attachment portion 125 once the attachment portion 125 is inserted into the holder 205. As previously described, the shape of the attachment portion 125 and the holder 205 need not be circular.

In an embodiment, the shape of the attachment portion 125 widens or flares or increases in diameter/width from the first edge to the second edge of the attachment portion 125. The degree of the widening can be minor or major based on the design and material of the attachment portion 125 and the holder 205. For example, the degree of widening is minor for the attachment portion 125 and the holder 205 being a hard metal. For example, the degree of widening is greater for the attachment portion 125 and the holder 205 being elastic polymers. The widening or conal guidance help improves the fit of the holder 205 on the attachment portion 125 as the holder 205 is engaged on the attachment portion 125, in particular when manufacturing tolerances are poor.

In an embodiment, the holder 205 includes a positioning liner attached along an interior of the holder 205 configured to help improve fit and security of the holder 205 when the holder 205 is arranged to engage with the attachment portion 125. For example, the positioning liner is formed from a stiff but elastic material and deforms around the attachment portion 125 when the holder 205 is slid over the attachment portion 125. Upon fully being seated, the positioning liner is arranged between the holder 205 and the attachment portion 125. In an embodiment, the attachment portion 125 includes a groove around the exterior surface of the attachment portion 125 and the positioning liner is configured to seat in the groove upon the holder 205 being engaged with the attachment portion 125. Thus, the groove serves as a locating or positioning feature for when the holder 205 is fully engaged with the attachment portion 125.

In an embodiment, the holder 205 and the attachment portion 125 include magnets configured to attract one another as the holder 205 is arranged to engage with the attachment portion 125. For example, holder 205 includes a magnet and the attachment portion 125 includes a magnet. Upon bringing the holder 205 and the attachment portion 125 together, the magnet in the attachment portion 125 can begin to attract the magnet in the holder 205 and assist in pulling the holder 205 onto the attachment portion 125. The magnets also increase retention or security of the holder 205 on the attachment portion 125. The magnets can also be arranged according to a predetermined design in both the holder 205 and the attachment portion 125 in order to help orient the holder 205 according to a desired angle around the attachment portion 125.

In an embodiment, upon engaging the attachment portion 125 in the holder 205, and upon engaging the first cylindrical portion 105 in the handle of the cosmetic applicator (FIG. 3C), the entire assembly can be attached to another device, such as the motion stabilizer device.

In an embodiment, the bottle can be engaged with the threaded adapter 100 via the second cylindrical portion. Generally, the neck of the bottle includes an exterior surface having threads thereon (male threads) to engage with the interior female threads in the handle of the cosmetic applicator. To secure, attach, or fasten the bottle to the threaded adapter 100, the pitch diameter of the second threading is similar or identical to the pitch diameter of the interior female threads in the handle and configured to engage with the male threads of the neck of the bottle. The bottle and/or the threaded adapter 100 can be rotated as the bottle and the threaded adapter 100 are brought together to engage the second threading with the threading of the neck of the bottle. Again, the pitch diameter of the bottle neck threading can be one of few commonly used dimensions, such as 10 mm, 13 mm, 15 mm, or less than 25 mm.

In an embodiment, the shape of the attachment portion 125 and the holder 205 can be non-circular (including oval) in order to assist in un-twisting or unlocking the bottle and/or the cosmetic applicator from the threaded adapter 100. Notably, twisting or locking the bottle and the cosmetic applicator onto the threaded adapter 100 can be performed while holding the two parts and twisting or rotating in the same direction when the first threading 120 and the second threading have a same twist or rotation direction. This secures both parts to the threaded adapter 100. Removing one part or the other from the threaded adapter 100 can then be performed by holding one part and twisting or rotating the other part in the opposite direction. However, removing the remaining part from the threaded adapter 100 can require holding the threaded adapter 100 itself while un-twisting the remaining part. When both the attachment portion 125 and the holder 205 are circular rings, slipping can occur and the user may need to remove the holder 205 from the attachment portion 125 to grip only the attachment portion 125. Therefore, a non-circular shape can be used for the attachment portion 125 and the holder 205 to prevent slipping between the attachment portion 125 and the holder 205. For example, the shape of the attachment portion 125 and the holder 205 can both be octagonal, and the interior corners/angles of the octagonal shape can provide sufficient resistance to slippage or a sufficient bite force between the attachment portion 125 and the holder 205. This can allow the user to keep the holder 205 on the attachment portion 125 and hold the holder 205 itself (or via the attached motion stabilizer device) to untwist or unlock the remaining part screwed onto the threaded adapter 100.

In an embodiment, the shape of the attachment portion 125 and the holder 205 can be circular, but the exterior surface of the attachment portion 125 includes a series of raised structures or teeth and the inner surface of the holder 205 includes a series of complementary teeth or depressions in order to assist in un-twisting or unlocking the bottle and/or the cosmetic applicator from the threaded adapter 100.

Advantageously, attaching the bottle to the threaded adapter 100 can allow for long-term storage of the cosmetic applicator with the bottle while still being attached to the threaded adapter 100. That is, the holder 205 and the threaded adapter 100 need not be removed from the cosmetic applicator in order to arrange the cosmetic applicator back in the bottle.

In an embodiment, the first cylindrical portion 105 is removably attached to the attachment portion 125. The first cylindrical portion 105 can be formed in various sizes and selected based on the inner diameter of the handle female threading. The selected first cylindrical portion 105 is twisted or rotated into the handle of the cosmetic applicator to secure the handle to the first cylindrical portion 105. The attachment portion 125 can be formed in a single size or design but capable of attaching to any variation of the first cylindrical portion 105. With the holder 205 engaged on the attachment portion 125, the cosmetic applicator with the first cylindrical portion 105 engaged therein is inserted through the attachment portion 125 (which, in embodiments, may be hollow) and brought in proximity of the attachment portion 125. In an embodiment, the first cylindrical portion 105 is attached to the attachment portion 125 via a push-fit, snap-fit, or the like. In an embodiment, the first cylindrical portion 105 is attached to the attachment portion 125 via a magnetic force. To prevent rotational slippage between the first cylindrical portion 105 and the attachment portion 125, a contact surface between the first cylindrical portion 105 and the attachment portion 125 includes a locking feature, such as a detent ball on the first cylindrical portion 105 that engages with a complementary groove on the attachment portion 125 (or vice-versa), a series of raised structures on the first cylindrical portion 105 and complementary depressions on the attachment portion 125 (or vice-versa), etc. Other mechanical and magnetic locking features can be used instead or in combination.

In one embodiment, the present disclosure relates to an attachment system for a cosmetic applicator, including a threaded adapter 100, including a first opening 110 defined by a first cylindrical portion 105, an exterior surface 115 of the first cylindrical portion 105 including a first threading 120, and an attachment portion 125 attached to the first cylindrical portion 105, the attachment portion 125 being hollow, an exterior surface of the attachment portion 125 having a shape; and a device adapter 200 including a holder 205 having a shape complementary to the shape of the attachment portion 125, the holder 205 configured to reversibly attach to the threaded adapter 100 via the attachment portion 125.

In an embodiment, the threaded adapter 100 further includes a second opening defined by a second cylindrical portion, the second cylindrical portion being attached to the attachment portion 125 opposite the first cylindrical portion 105, an interior surface of the second cylindrical portion including a second threading.

In an embodiment, the attachment portion 125 further includes a first edge disposed proximal to the first cylindrical portion 105 and a second edge disposed opposite the first edge on the attachment portion 125, and an abutment formed along the second edge of the attachment portion 125, the abutment configured to abut the holder 205 and prevent the holder 205 from moving beyond the second edge of the attachment portion 125.

In an embodiment, the holder 205 includes a positioning liner along an inner surface of the holder 205, the attachment portion 125 includes a groove around the exterior surface of the attachment portion 125, and the positioning liner is configured to sit in the groove of the attachment portion 125 when the holder 205 is fully engaged on the attachment portion 125.

In an embodiment, the exterior surface of the attachment portion 125 includes a locating feature and an inner surface of the holder 205 includes a complementary locating feature configured to engage with the locating feature of the attachment portion 125.

In an embodiment, the attachment portion 125 includes a first magnet and the holder 205 includes a second magnet, the first magnet configured to attract the second magnet and assist the holder 205 engage with the attachment portion 125.

In an embodiment, the exterior surface of the attachment portion 125 includes a series of teeth and an inner surface of the holder 205 includes a complementary series of depressions configured to engage with the series of teeth of the attachment portion 125.

In an embodiment, the shape of the exterior surface of the attachment portion 125 is non-circular and the shape of the holder 205 is complementary to the non-circular shape of the attachment portion 125.

In an embodiment, the shape of the exterior surface 115 of the first cylindrical portion 105 widens starting from a first edge disposed proximal to the first cylindrical portion 105 to a second edge disposed opposite the first edge on the attachment portion 125.

In an embodiment, the attachment portion 125 is removably attached to the first cylindrical portion 105.

In an embodiment, the first cylindrical portion 105 includes a locking feature configured to engage with a complementary locking feature on the attachment portion 125 and prevent rotational slippage between the first cylindrical portion 105 and the attachment portion 125.

In an embodiment, the second cylindrical portion is removably attached to the attachment portion 125.

In an embodiment, the second cylindrical portion includes a locking feature configured to engage with a complementary locking feature on the attachment portion 125 and prevent rotational slippage between the second cylindrical portion and the attachment portion 125.

In an embodiment, the device adapter 200 further includes a body 210 attached to the holder 205.

In an embodiment, the device adapter 200 is configured to attach to a motion stabilizer device via the body 210 attached to the holder 205.

In an embodiment, the first threading 120 is configured to engage with threading along an inner surface of a handle of the cosmetic applicator.

In an embodiment, the second threading is configured to engage with threading along a neck of a bottle.

Obviously, numerous modifications and variations of the present disclosure are possible in light of the above teachings. It is therefore to be understood that within the scope of the appended claims, the disclosure may be practiced otherwise than as specifically described herein.

This application claims priority to, and the benefit of U.S. Provisional Application No. 63/619,016, filed Jan. 9, 2024, titled “THREADED UNIVERSAL ADAPTED SYSTEM,” and French Patent application Serial No. FR2404278, filed on Apr. 25, 2024, the disclosures of which are incorporated herein by reference in their entireties.

1. An attachment system for a cosmetic applicator, comprising:
a threaded adapter, including
a first opening defined by a first cylindrical portion, an exterior surface of the first cylindrical portion including a first threading, and
an attachment portion attached to the first cylindrical portion, the attachment portion being hollow, an exterior surface of the attachment portion having a shape; and
a device adapter including a holder having a shape complementary to the shape of the attachment portion, the holder configured to reversibly attach to the threaded adapter via the attachment portion.

2. The attachment system of claim 1, wherein the threaded adapter further includes a second opening defined by a second cylindrical portion, the second cylindrical portion being attached to the attachment portion opposite the first cylindrical portion, an interior surface of the second cylindrical portion including a second threading.

3. The attachment system of claim 2, wherein the second threading is configured to engage with threading along a neck of a bottle.

4. The attachment system of claim 1, wherein the attachment portion further includes
a first edge disposed proximal to the first cylindrical portion and a second edge disposed opposite the first edge on the attachment portion, and
an abutment formed along the second edge of the attachment portion, the abutment configured to abut the holder and prevent the holder from moving beyond the second edge of the attachment portion.

5. The attachment system of claim 1, wherein
the holder includes a positioning liner along an inner surface of the holder,
the attachment portion includes a groove around the exterior surface of the attachment portion, and
the positioning liner is configured to sit in the groove of the attachment portion when the holder is fully engaged on the attachment portion.

6. The attachment system of claim 1, wherein the exterior surface of the attachment portion includes a locating feature and an inner surface of the holder includes a complementary locating feature configured to engage with the locating feature of the attachment portion.

7. The attachment system of claim 1, wherein the attachment portion includes a first magnet and the holder includes a second magnet, the first magnet configured to attract the second magnet and assist the holder engage with the attachment portion.

8. The attachment system of claim 1, wherein the exterior surface of the attachment portion includes a series of teeth and an inner surface of the holder includes a complementary series of depressions configured to engage with the series of teeth of the attachment portion.

9. The attachment system of claim 1, wherein the shape of the exterior surface of the attachment portion comprises a non-circular shape and the shape of the holder is complementary to the non-circular shape of the attachment portion.

10. The attachment system of claim 1, wherein the shape of the exterior surface of the first cylindrical portion widens starting from a first edge disposed proximal to the first cylindrical portion to a second edge disposed opposite the first edge on the attachment portion.

11. The attachment system of claim 1, wherein the attachment portion is removably attached to the first cylindrical portion.

12. The attachment system of claim 11, wherein the first cylindrical portion includes a locking feature configured to engage with a complementary locking feature on the attachment portion and prevent rotational slippage between the first cylindrical portion and the attachment portion.

13. The attachment system of claim 11, wherein a second cylindrical portion is removably attaches to the attachment portion.

14. The attachment system of claim 13, wherein the second cylindrical portion includes a locking feature configured to engage with a complementary locking feature on the attachment portion and prevent rotational slippage between the second cylindrical portion and the attachment portion.

15. The attachment system of claim 1, wherein the device adapter further includes a body attached to the holder.

16. The attachment system of claim 15, wherein the device adapter is configured to attach to a motion stabilizer device via the body attached to the holder.

17. The attachment system of claim 1, wherein the first threading is configured to engage with threading along an inner surface of a handle of the cosmetic applicator.
